(19) United States
(12) Patent Application Publication
(10) Pub. No.: US 2025/0007310 A1
(43) Pub. Date: Jan. 2, 2025

(54) ADAPTIVE CONTROL CIRCUIT FOR CONTROLLING A POWER SUPPLY VOLTAGE AND CONTROL METHOD THEREOF

(71) Applicant: Chengdu Monolithic Power Systems Co., Ltd., Chengdu (CN)

(72) Inventor: Xuefeng Chen, Hangzhou (CN)

(21) Appl. No.: 18/754,707

(22) Filed: Jun. 26, 2024

(30) Foreign Application Priority Data
Jun. 27, 2023 (CN) 202310769868.7

(51) Int. Cl. H02J 7/00

(52) U.S. Cl. CPC H02J 7/00712

(57) ABSTRACT

A control circuit for controlling a power supply voltage is provided. The control circuit includes a charging control circuit and a charging current source. The charging control circuit provides a charging control signal based on an input voltage and the power supply voltage. The charging current source is coupled to the input voltage and provides a charging current based on the charging control signal. When the input voltage decreases to an input reference voltage, the charging control signal controls the charging current source to provide the charging current. When the power supply voltage increases to a charging stop reference voltage, the charging control signal controls the charging current source to stop providing the charging current.

### CROSS-REFERENCE TO RELATED APPLICATIONS

This application claims priority to and the benefit of Chinese Patent Application No. 202310769868.7, filed on Jun. 27, 2023, which is incorporated herein by reference in its entirety.

### TECHNICAL FIELD

The present invention relates generally to electronic circuits, and more particularly but not exclusively to a control circuit used in a voltage converting circuit for controlling a power supply voltage and control methods.

### BACKGROUND OF THE INVENTION

With the increase of smartphone's functions, fast charging technology is born to meet high power consumption requirements. FIG. 1 schematically shows a conventional voltage converting circuit 10 used in a fast-charging power supply. As shown in FIG.1, an AC voltage Vac is rectified by a bridge rectifier 101 and then filtered by an input capacitor Cbus to obtain a DC voltage Vbus. The DC voltage Vbus is provided to a transformer T1 of the voltage converting circuit 10. The duty cycle of a primary side switch M1 coupled to the transformer T1 is controlled by a voltage converting control circuit 102 to control the transferred energy between the primary side and the secondary side of the transformer T1, thereby realizing the regulation of an output voltage Vout. The voltage converting control circuit 102 is powered by an auxiliary winding Lt. There is a proportional relationship between a power supply voltage Vcc provided by the auxiliary winding Lt and the output voltage Vout. The proportional coefficient is determined by the turns ratio of the auxiliary winding Lt to a secondary winding Ls, i.e., Vcc:Vout=N(Lt):N(Ls), wherein N represents the number of winding turns. It should be appreciated that, the power supply voltage Vcc should be maintained above a lower limit (usually 10V) to ensure the normal operation of the voltage converting control circuit 102. When the output voltage Vout is 3.3V, the turns ratio of the auxiliary winding Lt to the secondary winding Ls should be at least 3:1. However, if the turns ratio of the auxiliary winding Lt to the secondary winding Ls is 3:1, the power supply voltage Vcc is 60V when the output voltage Vout is 20V. In this case, high voltage devices are required in the voltage converting control circuit 102 and more power loss is produced.

### SUMMARY OF THE INVENTION

According to an embodiment of the present invention, a control circuit for controlling a power supply voltage is provided. The control circuit includes a charging control circuit and a charging current source. The charging control circuit provides a charging control signal based on an input voltage and the power supply voltage. The charging current source is coupled to the input voltage, and provides a charging current based on the charging control signal. When the input voltage decreases to an input reference voltage, the charging control signal controls the charging current source to provide the charging current. When the power supply voltage increases to a charging stop reference voltage, the charging control signal controls the charging current source to stop providing the charging current.

According to another embodiment of the present invention, a voltage converting circuit is provided. The voltage converting circuit includes a transformer, a primary switch, a voltage converting control circuit and a power supply control circuit. The voltage converting control circuit provides a primary control signal to control the primary switch. The power supply control circuit controls a power supply voltage. The power supply control circuit includes a charging control circuit and a charging current source. The charging control circuit provides a charging control signal based on an input voltage and the power supply voltage. The input voltage is received from an AC power supply through a rectifying circuit. The charging current source is coupled to the input voltage and provides a charging current to a power supply capacitor based on the charging control signal. When the input voltage decreases to an input reference voltage, the charging control signal controls the charging current source to provide the charging current. When the power supply voltage increases to a charging stop reference voltage, the charging control signal controls the charging current source to stop providing the charging current.

According to yet another embodiment of the present invention, a method for controlling a power supply voltage is provided. A charging current source is controlled to provide a charging current for charging a power supply capacitor when an input voltage decreases to an input reference voltage. The charging current source is controlled to stop providing the charging current when the power supply voltage increases to a charging stop reference voltage. The input reference voltage is adjusted when the input reference voltage is different from the input voltage at the time of stopping providing the charging current.

### BRIEF DESCRIPTION OF THE DRAWINGS

The present invention can be further understood with reference to the following detailed description and the appended drawings, wherein like elements are provided with like reference numerals. The drawings are only for illustration purpose. They may only show part of the devices and are not necessarily drawn to scale.

FIG. 1 schematically shows a conventional voltage converting circuit 10 used in a fast-charging power supply.

FIG. 2 schematically shows a voltage converting circuit 20 in accordance with an embodiment of the present invention.

FIG. 3 schematically shows working waveforms of a charging control circuit 23 in accordance with an embodiment of the present invention.

FIG. 4 schematically shows an input reference voltage adjusting circuit 40 in accordance with an embodiment of the present invention.

FIG. 5 schematically shows an input reference voltage adjusting circuit 50 in accordance with an embodiment of the present invention.

FIG. 6 schematically shows a voltage converting circuit 60 in accordance with an embodiment of the present invention.

FIG. 7 schematically shows a voltage converting circuit 70 in accordance with an embodiment of the present invention.

FIG. 8 schematically shows a voltage converting circuit 80 in accordance with an embodiment of the present invention.

FIG. 9 schematically shows a voltage converting circuit 90 in accordance with an embodiment of the present invention.

FIG. 10 schematically shows a voltage converting circuit 100 in accordance with an embodiment of the present invention.

FIG. 11 schematically shows a flowchart of a method 110 for controlling a power supply voltage in accordance with an embodiment of the present invention.

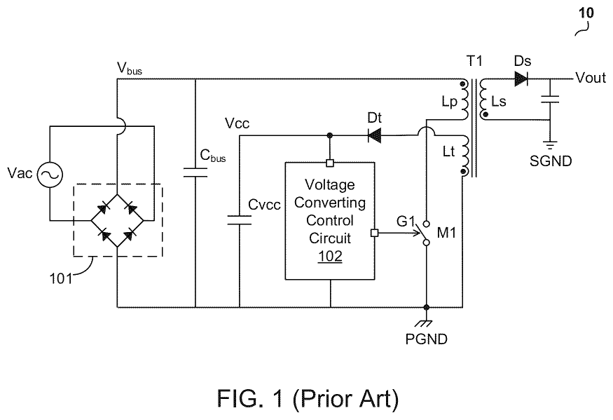

The use of the same reference label in different drawings indicates the same or like components.

### DETAILED DESCRIPTION

Various embodiments of the present invention will be described in detail below, and it should be noted that the embodiments described here are only for illustration. However, the present invention is not limited thereto. In the following description, numerous specific details, such as example circuits and example values for these circuit components, and methods are illustrated in order to provide a thorough understanding of the present invention. It will be apparent for persons having ordinary skill in the art that the present invention can be practiced without one or more specific details, or with other methods, components, materials. In other instances, well-known circuits, materials or methods are not shown or described in detail in order to avoid obscuring the present invention.

Throughout this description, the phrases “in one embodiment”, “in an embodiment”, “in some embodiments”, “in an example”, “in some examples”, “in one implementation”, and “in some implementations” as used to include both combinations and sub-combinations of various features described herein as well as variations and modifications thereof. These phrases used herein does not necessarily refer to the same embodiment, although it may. Additionally, persons having ordinary skill in the art will be appreciated that the drawings provided herein are for illustrative purposes and are not necessarily drawn to scale. The similar elements are provided with similar reference numerals. As used herein, the term “and/or” includes any combinations of one or more of the listed items.

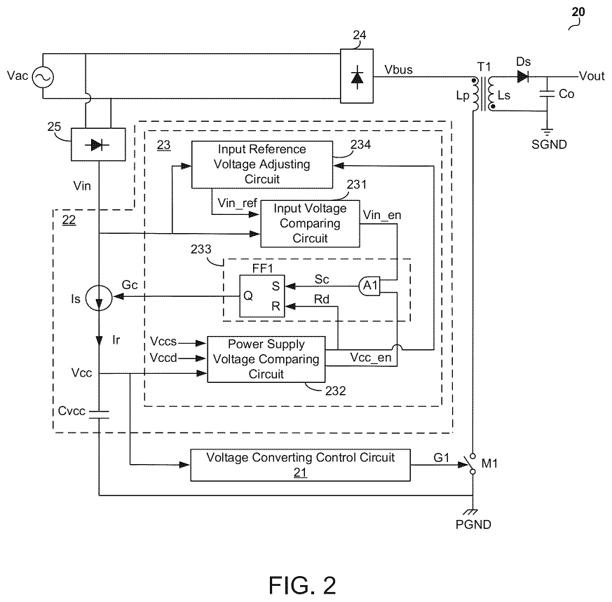

FIG. 2 schematically shows a voltage converting circuit 20 in accordance with an embodiment of the present invention. The voltage converting circuit 20 includes rectifying circuits 24 and 25, a transformer T1, a primary switch M1, a secondary switch Ds, a voltage converting control circuit 21 and a power supply control circuit 22. The rectifying circuit 24 rectifies an AC voltage Vac from an AC power supply and provides a DC voltage Vbus. The DC voltage Vbus is provided to the transformer T1. The transformer T1 has a primary winding Lp and a secondary winding Ls. The primary switch M1 is coupled to the primary winding Lp. The secondary switch Ds is coupled to the secondary winding Ls. The voltage converting control circuit 21 provides a primary control signal G1 to control the primary switch M1. To be specific, when the primary switch M1 is turned on, the secondary switch Ds is turned off, a current flowing through the primary winding Lp increases, the primary winding Lp stores energy. When the primary switch M1 is turned off, the secondary switch Ds is turned on, the energy stored in the primary winding Lp is transferred to the secondary winding Ls.

The rectifying circuit 25 rectifies the AC voltage Vac from the AC power supply and provides an input voltage Vin having a half-sine wave. The power supply control circuit 22 receives the input voltage Vin, and provides a power supply voltage Vcc to power the voltage converting control circuit 21.

In some embodiments, the rectifying circuit 24 includes a first bridge rectifier and an input capacitor, the rectifying circuit 25 includes a second bridge rectifier.

As shown in FIG. 2, the power supply control circuit 22 includes a power supply capacitor Cvcc, a charging current source Is and a charging control circuit 23. The power supply capacitor Cvcc has a charging terminal coupled to the charging current source Is and a ground terminal coupled to a primary reference ground PGND. The charging control circuit 23 provides a charging control signal Gc to control the charging current source Is. Under the control of the charging control signal Gc, the charging current source Is charges the power supply capacitor Cvcc to generate the power supply voltage Vcc. It should be appreciated that, both of the charging current source Is and the charging control circuit 23 could be integrated with the voltage converting control circuit 21 in an integrated circuit, and the power supply voltage Vcc could also be used for powering the integrated circuit.

In the embodiment of FIG. 2, the charging control circuit 23 includes an input voltage comparing circuit 231, a power supply voltage comparing circuit 232, a charging control logic circuit 233. The input voltage comparing circuit 231 receives the input voltage Vin and an input reference voltage Vin_ref, and provides an input voltage charging enable signal Vin_en. The power supply voltage comparing circuit 232 receives the power supply voltage Vcc, a charging reference voltage Vccs and a charging stop reference voltage Vccd, and provides a power supply voltage charging enable signal Vcc_en and a charging stop signal Rd. The charging control logic circuit 233 receives the input voltage charging enable signal Vin_en, the power supply voltage charging enable signal Vcc_en and the charging stop signal Rd, and provides the charging control signal Gc to control the charging current source Is.

In the embodiment of FIG. 2, the charging control logic circuit 233 includes a RS flip-flop FF1 and an AND gate A1. The AND gate A1 provides a charging set signal Sc based on the input voltage charging enable signal Vin_en and the power supply voltage charging enable signal Vcc_en. The RS flip-flop FF1 has a set terminal, a reset terminal and an output terminal. The set terminal of the RS flip-flop FF1 is configured to receive the charging set signal Sc. The reset terminal of the RS flip-flop FF1 is configured to receive the charging stop signal Rd. The output terminal of the RS flip-flop FF1 is configured to provide the charging control signal Gc. When the input voltage Vin decreases to the input reference voltage Vin_ref and the power supply voltage Vcc is lower than the charging reference voltage Vccs, the charging control signal Gc controls the charging current source Is to charge the power supply capacitor Cvcc. When the power supply voltage Vcc increases to the charging stop reference voltage Vccd, the charging control signal Gc controls the charging current source Is to stop charging the power supply capacitor Cvcc. In one embodiment, the charging control circuit 23 further includes an input reference voltage adjusting circuit 234. The input reference voltage adjusting circuit 234 receives the charging stop signal Rd and the input voltage Vin, and adjusts the input reference voltage Vin_ref based on the input voltage Vin and the charging stop signal Rd. For example, the input reference voltage Vin_ref could be adjusted based on the value of the input voltage Vin at the time point when the charging of the power supply capacitor Cvcc is stopped.

In FIG. 2, the charging stop signal Rd is provided to the input reference voltage adjusting circuit 234 to indicate a charging stop time (i.e., the time point when the charging current source Is stops providing a charging current Ir). Persons skilled in the art should be appreciated that, other signals (e.g., the charging control signal Gc) that are capable of indicating the charging stop time could also be provided to the input reference voltage adjusting circuit 234.

The input voltage comparing circuit 231 receives the input reference voltage Vin_ref and the input voltage Vin. When the input voltage Vin decreases to the input reference voltage Vin_ref, the input voltage charging enable signal Vin_en provided by the input voltage comparing circuit 231 is enabled. The input voltage comparing circuit 231 may be a comparator. It should be appreciated that, other circuits that could generate signals to indicate that the input voltage Vin decreases to the input reference voltage Vin_ref could also be utilized as the input voltage comparing circuit.

In one embodiment, the power supply voltage comparing circuit 232 may be a hysteresis comparator. In other embodiments, the power supply voltage comparing circuit 232 may include two distinct comparators. In one embodiment, the charging reference voltage Vccs is lower than the charging stop reference voltage Vccd. When the power supply voltage Vcc decreases to the charging reference voltage Vccs, the power supply voltage charging enable signal Vcc_en is enabled, the charging stop signal Rd is disabled. When the power supply voltage Vcc increases to the charging stop reference voltage Vccd, the power supply voltage charging enable signal Vcc_en is disabled, the charging stop signal Rd is enabled. It should be appreciated that, other circuits that could generate signals to indicate that the power supply voltage Vcc decreases to the charging reference voltage Vccs or increases to the charging stop reference voltage Vccd could also be utilized as the power supply voltage comparing circuit.

The state of the signal may be represented by different voltage levels. For example, a high level is indicative of an enabled state of the signal, and a low level is indicative of a disabled state of the signal. In another example, the high level is indicative of the disabled state of the signal, and the low level is indicative of the enabled state of the signal. In the embodiments of the present invention, other features of the signal could also be utilized to indicate the state of the signal, for example, a rise edge and a fall edge of the signal. It should also be noted that, the enabled states (or disabled state) of different signals do not need to be consistent and could be different from each other.

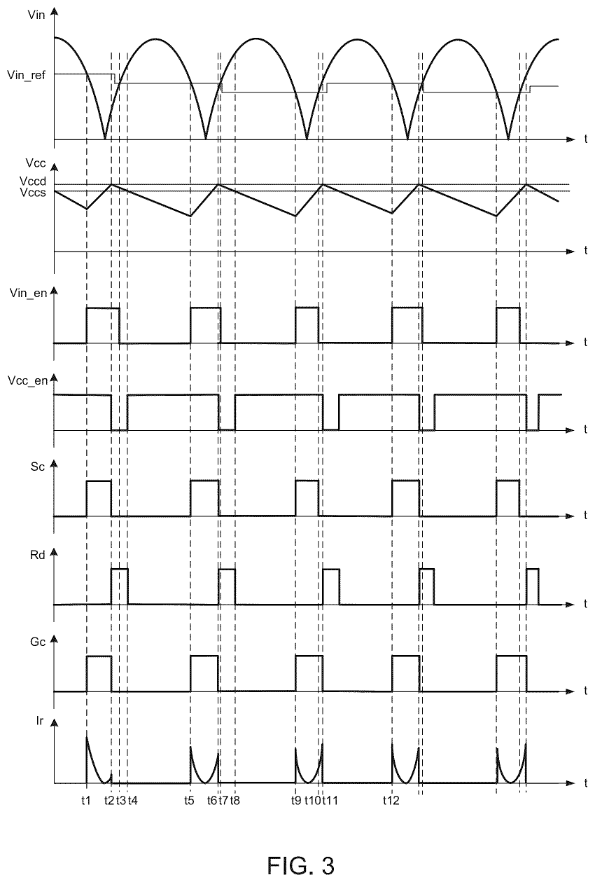

FIG. 3 schematically shows working waveforms of the charging control circuit 23 in accordance with an embodiment of the present invention. The working principle of the charging control circuit 23 is illustrated below with reference to FIGS. 2-3.

As shown in FIG. 3, the input voltage Vin has a rectified half-sine wave obtained by rectifying the AC voltage Vac from the AC power supply. At time t1, the input voltage Vin decreases to the input reference voltage Vin_ref. The input voltage charging enable signal Vin_en provided by the input voltage comparing circuit 231 becomes high level. At the same time, the power supply voltage Vcc is lower than the charging reference voltage Vccs, the power supply voltage charging enable signal Vcc_en provided by the power supply voltage comparing circuit 232 is high level and the charging stop signal Rd is low level. Accordingly, the charging set signal Sc provided by the AND gate A1 becomes high level. The RS flip-flop FF1 is triggered by a rise edge of the charging set signal Sc to provide the charging control signal Gc to control the charging current source Is for providing the charging current Ir. The power supply capacitor Cvcc is charged, the power supply voltage Vcc increases. At time t2, the power supply voltage Vcc increases to the charging stop reference voltage Vccd, the power supply voltage charging enable signal Vcc_en becomes low level and the charging stop signal Rd becomes high level, the RS flip-flop FF1 is reset, the charging control signal Gc controls the charging current source Is to stop providing the charging current Ir. Then, during the power supply capacitor Cvcc powers the voltage converting control circuit 21, the power supply voltage Vcc decreases gradually. Meanwhile, because the input reference voltage Vin_ref is higher than the input voltage Vin at time t2 (i.e., the charging stop time), the input reference voltage Vin_ref is decreased by the input reference voltage adjusting circuit 234. At time t3, the input voltage Vin increases to the input reference voltage Vin_ref, the input voltage charging enable signal Vin_en becomes low level. At time t4, the power supply voltage Vcc decreases to the charging reference voltage Vccs, the power supply voltage charging enable signal Vcc_en becomes high level and the charging stop signal Rd becomes low level. However, the input voltage charging enable signal Vin_en maintains low level at this moment, thus the RS flip-flop FF1 could not be triggered. The charging current Ir is not provided to charge the power supply capacitor Cvcc.

At time t5, the input voltage Vin decreases to the input reference voltage Vin_ref again, the input voltage charging enable signal Vin_en becomes high level and the power supply voltage charging enable signal Vcc_en maintains high level, thus the charging set signal Sc provided by the AND gate A1 sets the RS flip-flop FF1. The charging control signal Gc controls the charging current source Is to provide the charging current Ir for charging the power supply capacitor Cvcc. The power supply voltage Vcc increases again. At time t6, the power supply voltage Vcc increases to the charge stop reference Vccd, the power supply voltage charging enable signal Vcc_en becomes low level and the charging stop signal Rd becomes high level, the RS flip-flop FF1 is reset. The charging control signal Gc controls the charging current source Is to stop providing the charging current Ir. After that, since the input reference voltage Vin_ref is higher than the input voltage Vin at time t6 (i.e., the charging stop time), the input reference voltage Vin_ref is decreased again. At time t7, the input voltage Vin increases to the input reference voltage Vin_ref, the input voltage charging enable signal Vin_en becomes low level. At time t8, the power supply voltage Vcc decreases to the charging reference voltage Vccs, the power supply voltage charging enable signal Vcc_en becomes high level and the charging stop signal Rd becomes low level. However, the input voltage charging enable signal Vin_en maintains low level at this moment, thus the RS flip-flop FF1 could not be triggered. The charging current Ir is not provided to charge the power supply capacitor Cvcc.

At time t9, the input voltage Vin decreases to the input reference voltage Vin_ref and the power supply voltage Vcc is lower than the charging reference voltage Vccs, thus both of the input voltage charging enable signal Vin_en and the power supply voltage charging enable signal Vcc_en are high level, the charging current Ir is provided to charge the power supply capacitor Cvcc again. At time t10, the input voltage Vin increases to the input reference voltage Vin_ref, the input voltage charging enable signal Vin_en becomes low level. At time t11, the power supply voltage Vcc increases to the charge stop reference Vccd, the power supply voltage charging enable signal Vcc_en becomes low level and the charging stop signal Rd becomes high level, the RS flip-flop FF1 is reset. The charging control signal Gc controls the charging current source Is to stop providing the charging current Ir. Afterwards, since the input reference voltage Vin_ref is lower than the input voltage Vin at time t11 (i.e., the charging stop time), the input reference voltage Vin_ref is increased subsequently.

By adjusting the input reference voltage Vin_ref, the power supply capacitor Cvcc is charged when the input voltage Vin is at its valley portions, and the time duration of providing the charging current Is is controlled to be substantially symmetric with respect to the minimum value of the input voltage Vin (e.g. zero voltage point). It should be understood that “substantially” is a term of art, and is meant to convey the principle that relationship such simultaneity or perfect synchronization cannot be met with exactness, but only within the tolerances of the technology available to a practitioner of the art under discussion. Therefore, the power dissipation could be reduced.

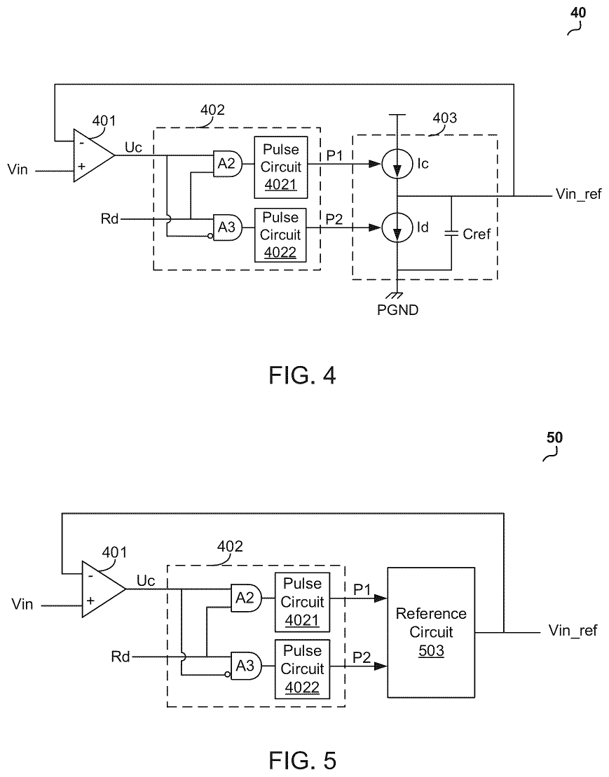

FIG. 4 schematically shows an input reference voltage adjusting circuit 40 in accordance with an embodiment of the present invention. As shown in FIG. 4, the input reference voltage adjusting circuit 40 receives the input voltage Vin and the charging stop signal Rd, and provides the input reference voltage Vin_ref based on the input voltage Vin and the charging stop signal Rd. In other words, the input reference voltage adjusting circuit 40 adjusts the input reference voltage Vin_ref based on the input voltage Vin at the charging stop time. The input reference voltage adjusting circuit 40 includes a reference comparing circuit 401, a reference adjusting logic circuit 402 and a reference circuit 403. The reference comparing circuit 401 receives the input voltage Vin and the input reference voltage Vin_ref, and provides a voltage adjusting control signal Uc. The reference adjusting logic circuit 402 receives the voltage adjusting control signal Uc and the charging stop signal Rd, and provides a reference increasing signal P1 and a reference decreasing signal P2. The reference adjusting logic circuit 402 includes AND gates A2 and A3, and pulse circuits 4021 and 4022. The AND gate A2 receives the voltage adjusting control signal Uc and the charging stop signal Rd, and provides an AND result to the pulse circuit 4021. The pulse circuit 4021 provides the reference increasing signal P1 based on the AND result of the AND gate A2. The AND gate A3 receives the inverted voltage adjusting control signal Uc and the charging stop signal Rd, and provides an AND result to the pulse circuit 4022. The pulse circuit 4022 provides the reference decreasing signal P2 based on the AND result of the AND gate A3.

In one embodiment, the reference increasing signal P1 and the reference decreasing signal P2 are pulse signals. In one embodiment, when the voltage adjusting control signal Uc is high level (i.e., the input voltage Vin is higher than the input reference voltage Vin_ref), and meanwhile the charging stop signal Rd is high level (i.e., the charging is stopped), the reference increasing signal P1 has a pulse to control the reference circuit 403 to increase the input reference voltage Vin_ref. When the voltage adjusting control signal Uc is low level (i.e., the input voltage Vin is lower than the input reference voltage Vin_ref), and meanwhile the charging stop signal Rd is high level (i.e., the charging is stopped), the reference decreasing signal P2 has a pulse to control the reference circuit 403 to decrease the input reference voltage Vin_ref.

In the embodiment of FIG. 4, the reference circuit 403 is an analog reference circuit including an increasing current source Ic, a decreasing current source Id and a reference capacitor Cref. The reference increasing signal P1 controls the increasing current source Ic, the reference decreasing signal P2 controls the decreasing current source Id. When the input voltage Vin is higher than the input reference voltage Vin_ref and meanwhile the charging is stopped, the reference increasing signal P1 controls the increasing current source Ic to charge the reference capacitor Cref, the input reference voltage Vin_ref is increased. When the input voltage Vin is lower than the input reference voltage Vin_ref and meanwhile the charging is stopped, the reference decreasing signal P2 controls the decreasing current source Id to discharge the reference capacitor Cref, the input reference voltage Vin_ref is decreased.

FIG. 5 schematically shows an input reference voltage adjusting circuit 50 in accordance with an embodiment of the present invention. As shown in FIG. 5, the input reference voltage adjusting circuit 50 receives the input voltage Vin and the charging stop signal Rd, and provides the input reference voltage Vin_ref based on the input voltage Vin and the charging stop signal Rd. The input reference voltage adjusting circuit 50 includes the reference comparing circuit 401, the reference adjusting logic circuit 402 and a reference circuit 503. In the embodiment of FIG. 5, the reference circuit 503 may be a digital reference circuit configured to receive the reference increasing signal P1 and the reference decreasing signal P2. The reference circuit 503 increases the input reference voltage Vin_ref based on the reference increasing signal P1 and decreases the input reference voltage Vin_ref based on the reference decreasing signal P2. In one embodiment, the input reference voltage Vin_ref is increased by a fixed increasing value and decreased by a fixed decreasing value. The increasing value and the decreasing value could be same or different.

In some applications, because of the impact of the post-stage circuit, for example, there is a high resistance in a connection node between the voltage converting control circuit 21 and the input voltage Vin. The waveform shape of the input voltage Vin may be partially consistent with the rectified half-sine wave as shown in FIG. 3. For instance, the waveform shape of the input voltage Vin shows a filtered waveform shape without any voltage valley. In that case, the input voltage Vin is required to be regulated to show the rectified half-sine wave shown in FIG. 3, to ensure the normal operation of the power supply control circuit 22.

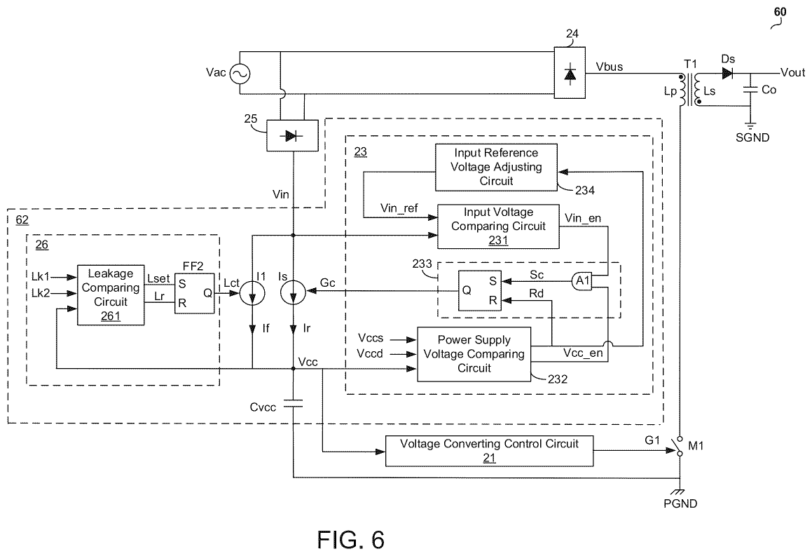

FIG. 6 schematically shows a voltage converting circuit 60 in accordance with an embodiment of the present invention. In the embodiment of FIG. 6, the voltage converting circuit 60 includes a power supply control circuit 62. The power supply control circuit 62 includes the power supply capacitor Cvcc, the charging current source Is, the charging control circuit 23, a leakage current source I1 and a leakage control circuit 26. The leakage control circuit 26 receives the power supply voltage Vcc, and compares the power supply voltage Vcc with a leakage charging reference voltage Lk1 and a leakage stop reference voltage Lk2. When the power supply voltage Vcc decreases to the leakage charging reference voltage Lk1, the leakage control circuit 26 provides a leakage control signal Lct to control the leakage current source I1 to charge the power supply capacitor Cvcc. When the power supply voltage Vcc increases to the leakage stop reference voltage Lk2, the leakage control circuit 26 provides the leakage control signal Lct to control the leakage current source I1 to stop providing a leakage current If.

In the embodiment of FIG. 6, the leakage control circuit 26 includes a leakage comparing circuit 261 and a RS flip-flop FF2. The leakage comparing circuit 261 compares the power supply voltage Vcc with the leakage charging reference voltage Lk1 and the leakage stop reference voltage Lk2, and provides a leakage set signal Lset and a leakage reset signal Lr based on the comparison result. The RS flip-flop FF2 has a set terminal, a reset terminal and an output terminal. The set terminal of the RS flip-flop FF2 is configured to receive the leakage set signal Lset. The reset terminal of the RS flip-flop FF2 is configured to receive the leakage reset signal Lr. The output terminal of the RS flip-flop FF2 is configured to provide the leakage control signal Lct. In one embodiment, the leakage charging reference voltage Lk1 is lower than the leakage stop reference voltage Lk2.

In some embodiments, the leakage comparing circuit 261 may be a hysteresis comparator. In other embodiments, the leakage comparing circuit 261 may include two distinct comparators.

In the embodiment of FIG. 6, the input voltage Vin is pulled down by the leakage current source I1 with a small current. The impact of the internal high resistance and the large parasitic capacitance of the voltage converting control circuit 21 on the input voltage Vin through the power supply voltage Vcc is eliminated. Therefore, the input voltage Vin could maintain the rectified half-sine wave and the power supply control circuit 62 could operate normally.

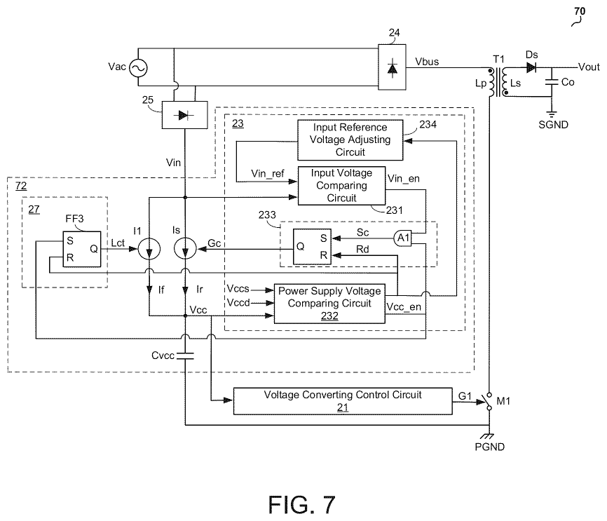

FIG. 7 schematically shows a voltage converting circuit 70 in accordance with an embodiment of the present invention. Compared with the embodiment of FIG. 6, a power supply control circuit 72 of the embodiment of FIG. 7 includes a leakage control circuit 27. The leakage control circuit 27 receives the charging stop signal Rd and the power supply voltage charging enable signal Vcc_en, and provides the leakage control signal Lct to control the leakage current source I1. In FIG. 7, the leakage control circuit 27 includes a RS flip-flop FF3. The RS flip-flop FF3 includes a set terminal, a reset terminal and an output terminal. The set terminal of the RS flip-flop FF3 is configured to receive the power supply voltage charging enable signal Vcc_en. The reset terminal of the RS flip-flop FF3 is configured to receive the charging stop signal Rd. The output terminal of the RS flip-flop FF3 is configured to provide the leakage control signal Lct. When the power supply voltage charging enable signal Vcc_en indicated that the power supply voltage Vcc decreases to the charging reference voltage Vccs, the RS flip-flop FF3 is set. The leakage control signal Lct controls the leakage current source I1 to provide the leakage current If for charging the power supply capacitor Cvcc. When the charging stop signal Rd indicates that the power supply voltage Vcc increases to the charging stop reference voltage Vccd, the leakage control signal Lct controls the leakage current source I1 to stop providing the leakage current If.

In some applications, when a circuit powered by the power supply voltage Vcc (e.g., the voltage converting control circuit 21) has a large power consumption, the power supply capacitor Cvcc is required to be charged in each cycle of the input voltage Vin to maintain the power supply voltage Vcc. In that case, compared with the embodiment of FIG. 2, the power supply voltage charging enable signal Vcc_en is not used in the charging process of the power supply capacitor Cvcc.

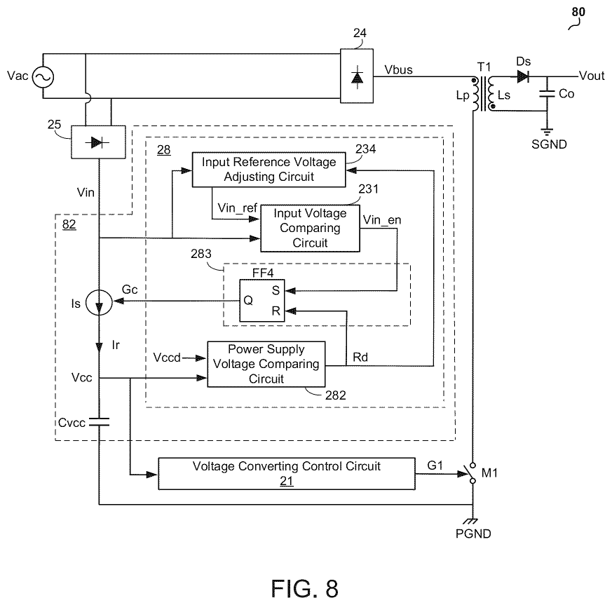

FIG. 8 schematically shows a voltage converting circuit 80 in accordance with an embodiment of the present invention. The voltage converting circuit 80 includes rectifiers 24 and 25, the transformer T1, the primary switch M1, the secondary switch Ds, the voltage converting control circuit 21 and a power supply control circuit 82. The power supply control circuit 82 includes the power supply capacitor Cvcc, the charging current source Is and a charging control circuit 28. The charging control circuit 28 provides the charging control signal Gc to control the charging current source Is. The charging current source Is charges the power supply capacitor Cvcc to generate the power supply voltage Vcc for powering the voltage converting control circuit 21. It should be appreciated that, both of the charging current source Is and the charging control circuit 28 could be integrated with the voltage converting control circuit 21 in the integrated circuit, and the power supply voltage Vcc could also be used for powering the integrated circuit.

In the embodiment of FIG. 8, the charging control circuit 28 includes the input voltage comparing circuit 231, a power supply voltage comparing circuit 282, a charging control logic circuit 283 and the input reference voltage adjusting circuit 234. The components and the working principles of the input voltage comparing circuit 231 and the input reference voltage adjusting circuit 234 have been illustrated in detail before, and descriptions thereof are omitted here. The power supply voltage comparing circuit 282 receives the power supply voltage Vcc and the charging stop reference voltage Vccd, and provides the charging stop signal Rd to the charging control logic circuit 283 and the input reference voltage adjusting circuit 234. The charging control logic circuit 283 receives the input voltage charging enable signal Vin_en and the charging stop signal Rd, and provides the charging control signal Gc to control the charging current source Is.

In the embodiment of FIG. 8, the charging control logic circuit 283 includes a RS flip-flop FF4. The RS flip-flop FF4 has a set terminal, a reset terminal and an output terminal. The set terminal of the RS flip-flop FF4 is configured to receive the input voltage charging enable signal Vin_en. The reset terminal of the RS flip-flop FF4 is configured to receive the charging stop signal Rd. The output terminal of the RS flip-flop FF4 is configured to provide the charging control signal Gc. When the input voltage Vin decreases to the input reference voltage Vin_ref, the charging control signal Gc controls the charging current source Is to charge the power supply capacitor Cvcc. When the power supply voltage Vcc increases to the charging stop reference voltage Vccd, the charging control signal Gc controls the charging current source Is to stop charging the power supply capacitor Cvcc. Compared with the embodiment in FIG. 2, the charging control logic circuit 283 shown in FIG. 8 provides the charging control signal Gc to control the charging current source Is for providing the charging current Ir based on the input voltage charging enable signal Vin_en, rather than the combination of the input voltage charging enable signal Vin_en and the power supply voltage charging enable signal Vcc_en.

The working principle of the charging control circuit 28 is similar to the charging control circuit 23 and will not be repeated here for brevity.

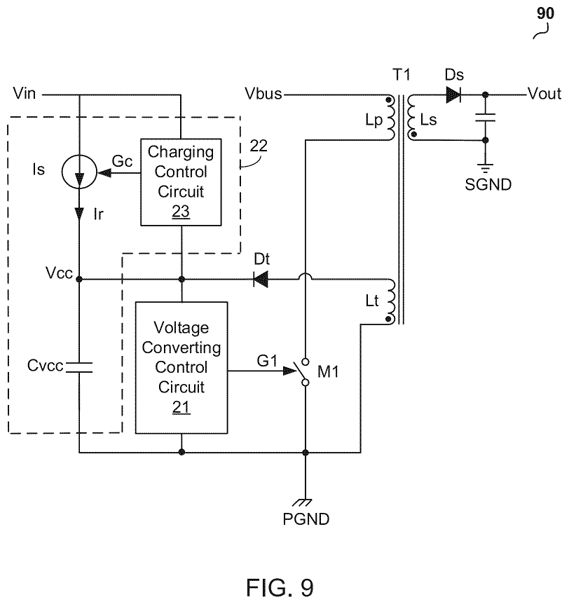

FIG. 9 schematically shows a voltage converting circuit 90 in accordance with an embodiment of the present invention. The voltage converting circuit 90 includes the transformer T1, the primary switch M1, the secondary switch Ds, the voltage converting control circuit 21 and the power supply control circuit 22. The transformer T1 has the primary winding Lp, the secondary winding Ls and an auxiliary winding Lt. The primary switch M1 is coupled to the primary winding Lp. The secondary switch Ds is coupled to the secondary winding Ls. The voltage converting control circuit 21 provides the primary control signal G1 to the control terminal of the primary switch M1 for controlling the primary switch M1. The charging current source Is charges the power supply capacitor Cvcc to generate the power supply voltage Vcc. The power supply control circuit 22 includes the charging control circuit 23, the charging current source Is and the power supply capacitor Cvcc. The charging control circuit 23 receives the input voltage Vin and the power supply voltage Vcc. When the input voltage Vin decreases to the input reference voltage Vin_ref and the power supply voltage Vcc is lower than the charging reference voltage Vccs, the charging control circuit 23 provides the charging control signal Gc to control the charging current source Is to charge the power supply capacitor Cvcc.

In the embodiment of FIG. 9, the auxiliary winding Lt of the transformer T1 is coupled to the charging terminal of the power supply capacitor Cvcc through a diode Dt. When a voltage provided by the auxiliary winding Lt is higher than a maximum voltage of the power supply capacitor Cvcc reached by being charged by the input voltage Vin (i.e., the charging stop reference voltage Vccd), the power supply capacitor Cvcc is charged by the auxiliary winding Lt. Persons skilled in the art could properly set the value of the charging stop reference voltage Vccd and the turns ratio of the auxiliary winding Lt to the secondary winding Ls according to the specifications and requirements of applications. Thereby, in order to maintain the power supply voltage Vcc, when the output voltage Vout is relatively low, the charging control circuit 23 controls the charging current source Is to charge the power supply capacitor Cvcc; and when the output voltage Vout is relatively high, the power supply capacitor Cvcc is charged by the auxiliary winding Lt.

When the output voltage Vout is low, the power supply capacitor Cvcc is charged by the charging current source Is instead of the auxiliary winding Lt, thus high turns ratio of the auxiliary winding Lt to the secondary winding Ls is not necessary. It means the turns ratio of the auxiliary winding Lt to the secondary winding Ls could be 1:1 or 1:2, or even lower. When the turns ratio of the auxiliary winding Lt to the secondary winding Ls is 1:2, even if the output voltage Vout is 20V, the power supply voltage Vcc is 10V. That is to say, when the turns ratio of the auxiliary winding Lt to the secondary winding Ls is low, even if the output voltage Vout is relatively high, the voltage provided by the auxiliary winding Lt is low, thus the voltage converting control circuit 21 does not need to withstand the high voltage. As a result, high voltage devices are not required, and the power dissipation caused by the high voltage is also reduced.

It should be appreciated that, in the embodiment of FIG. 9, the power supply control circuit 22 could be replaced by the power supply control circuit 82. The working principle of the power supply control circuit 82 has been illustrated before and will not be repeated for brevity.

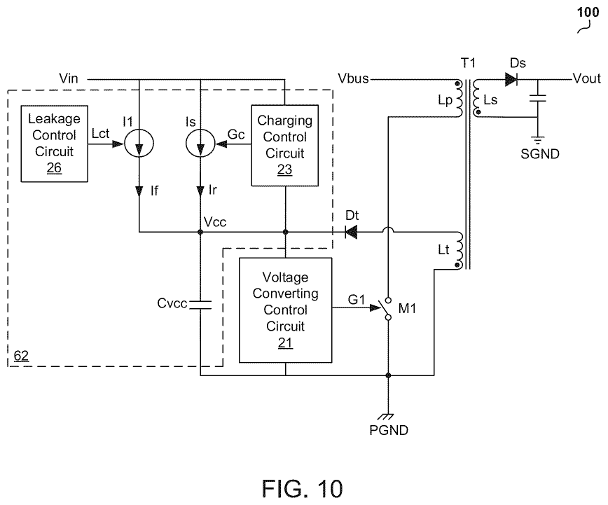

FIG. 10 schematically shows a voltage converting circuit 100 in accordance with an embodiment of the present invention. Compared with the embodiment of FIG. 9, the voltage converting circuit 100 shown in FIG. 10 includes the power supply control circuit 62. As illustrated above, when the power supply voltage Vcc decreases to the leakage charging reference voltage Lk1, the power supply capacitor Cvcc is charged by the leakage current source I1; and when the power supply voltage Vcc increases to the leakage stop reference voltage Lk2, the leakage current source I1 stops providing the leakage current If.

It should be appreciated that, in the embodiment of FIG. 10, the power supply control circuit 62 could be replaced by the power supply control circuit 72. The working principle of the power supply control circuit 72 has been illustrated before and will not be repeated for brevity.

It should be appreciated that, the logic circuits in the embodiments of the present invention, for example, the charging control logic circuit 233, AND gates A1-A3 and flip-flops FF1-FF4 just for illustration purposes. The logic circuits could be changed along with the change of the polarity of the input/output signal of the logic circuits.

The voltage converting circuit 20, 60, 70, 80, 90 and 100 have a FLYBACK topology in the embodiments of the present invention. It should be appreciated that, the voltage converting circuit 20, 60, 70, 80, 90 and 100 could have other topologies (e.g., Buck topology and Boost topology). The power supply control circuit in the embodiments of the present invention could also be utilized in the voltage converting circuit having different topologies.

In some embodiments, some or all of the charging control circuit 23, the leakage control circuit 26, the leakage control circuit 27, the charging control circuit 28, the charging current source Is, the leakage current source I1 are integrated with the voltage converting control circuit 21 in the integrated circuit. In one embodiment, the charging current source Is includes a switch. A control terminal of the switch is configured to receive the charging control signal Gc.

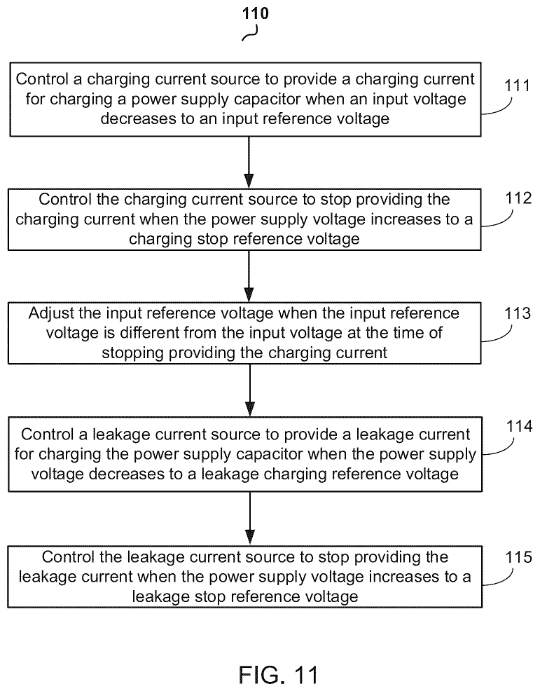

FIG. 11 schematically shows a flowchart of a method 110 for controlling a power supply voltage in accordance with an embodiment of the present invention. The method 110 could be used to control a charging current source to charge a power supply capacitor for generating a power supply voltage to power an integrated circuit. In some embodiment, the integrated circuit may include the voltage converting control circuit 21 as shown in FIG. 2 and FIGS. 6-10. The charging current source is coupled between an input voltage and the power supply capacitor. The input voltage is received from an AC power supply through a rectifying circuit. The AC power supply provides an AC voltage having a sine wave, thus the waveform shape of the input voltage shows a rectified half-sine wave. The method 110 includes steps 111-113.

In step 111, the charging current source is controlled to provide a charging current for charging the power supply capacitor when the input voltage decreases to an input reference voltage. In step 112, the charging current source is controlled to stop providing the charging current when the power supply voltage increases to a charging stop reference voltage. In step 113, the input reference voltage is adjusted when the input reference voltage is different from the input voltage at the time of stopping providing the charging current.

The method 110 illustrated above could be performed in different orders.

In one embodiment, the step 113 further includes the following steps. The input reference voltage is decreased by a fixed increasing value when the input reference voltage is higher than the input voltage at the time of stopping providing the charging current. The input reference voltage is increased by a fixed decreasing value when the input reference voltage is lower than the input voltage at the time of stopping providing the charging current. The increasing value and the decreasing value could be same or different.

In one embodiment, a leakage current source is coupled between the input voltage and the power supply capacitor, and the method 110 further includes steps 114-115.

In step 114, the leakage current source is controlled to provide a leakage current for charging the power supply capacitor when the power supply voltage decreases to a leakage charging reference voltage. In step 115, the leakage current source is controlled to stop providing the leakage current when the power supply voltage increases to a leakage stop reference voltage.

In one embodiment, the leakage stop reference voltage is higher than the leakage charging reference voltage.

In one embodiment, in step 111, the charging current source is controlled to provide the charging current for charging the power supply capacitor when (i) the input voltage decreases to the input reference voltage, and (ii) the power supply voltage is lower than a charging reference voltage.

In one embodiment, the leakage stop reference voltage is equal to the charging stop reference voltage, the leakage charging reference voltage is equal to the charging reference voltage.

It should be understood, the circuit and the workflow given in the present invention are just for schematic illustration. Any circuit can realize the function and operation of the present invention does not depart from the spirit and the scope of the invention.

While specific embodiments of the present invention have been provided, it is to be understood that these embodiments are for illustration purposes and not limiting. Since the invention can be practiced in various forms without distracting the spirit or the substance of the invention. It should be appreciated that the above embodiments are not confined to any aforementioned specific detail but should be explanatory broadly within the spirit and scope limited by the appended claims. Thus, all the variations and modification falling into the scope of the claims and their equivalents should be covered by the appended claims.

What is claimed is:

1. A control circuit for controlling a power supply voltage, comprising:
a charging control circuit configured to provide a charging control signal based on an input voltage and the power supply voltage;
a charging current source coupled to the input voltage, and configured to provide a charging current based on the charging control signal; and wherein
when the input voltage decreases to an input reference voltage, the charging control signal controls the charging current source to provide the charging current, when the power supply voltage increases to a charging stop reference voltage, the charging control signal controls the charging current source to stop providing the charging current.

2. The control circuit of claim 1, the input reference voltage is adjusted to get the time duration of providing the charging current to be substantially symmetric with respect to a minimum value of the input voltage.

3. The control circuit of claim 1, wherein the charging control circuit is configured to adjust the input reference voltage when the input reference voltage is different from the input voltage at the time of stopping providing the charging current.

4. The control circuit of claim 1, wherein the charging control circuit comprises:
an input voltage comparing circuit configured to provide an input voltage charging enable signal based on the input voltage and the input reference voltage;
a power supply voltage comparing circuit configured to provide a charging stop signal based on the power supply voltage and the charging stop reference voltage; and
a charging control logic circuit configured to provide the charging control signal to control the charging current source based on the input voltage charging enable signal and the charging stop signal.

5. The control circuit of claim 4, wherein the power supply voltage comparing circuit is further configured to provide a power supply voltage charging enable signal based on the power supply voltage and a charging reference voltage, and the charging control logic circuit is further configured to provide the charging control signal based on the input voltage charging enable signal, the power supply voltage charging enable signal and the charging stop signal.

6. The control circuit of claim 5, wherein:
when the input voltage decreases to the input reference voltage and the power supply voltage is lower than the charging reference voltage, the charging control signal controls the charging current source to provide the charging current.

7. The control circuit of claim 4, wherein the charging control circuit further comprises an input reference voltage adjusting circuit configured to adjust the input reference voltage based on the input voltage and the charging stop signal.

8. The control circuit of claim 7, wherein the input reference voltage adjusting circuit comprises:
a reference comparing circuit configured to provide a voltage adjusting control signal based on the input voltage and the input reference voltage;
a reference adjusting logic circuit configured to provide a reference increasing signal and a reference decreasing signal based on the voltage adjusting control signal and the charging stop signal; and
a reference circuit configured to provide the input reference voltage based on the reference increasing signal and the reference decreasing signal.

9. The control circuit of claim 1, wherein the input voltage is configured be received from an AC power supply through a rectifying circuit.

10. The control circuit of claim 1, further comprising:
a leakage control circuit configured to provide a leakage control signal based on the power supply voltage, a leakage charging reference voltage and a leakage stop reference voltage;
a leakage current source coupled in parallel with the charging current source, and configured to provide a leakage current based on the leakage control signal;
wherein when the power supply voltage decreases to the leakage charging reference voltage, the leakage control signal is configured to control the leakage current source to provide the leakage current; and
when the power supply voltage increases to the leakage stop reference voltage, the leakage control signal is configured to control the leakage current source to stop providing the leakage current.

11. The control circuit of claim 10, wherein the leakage stop reference voltage is equal to the charging stop reference voltage.

12. A voltage converting circuit, comprising:
a transformer;
a primary switch;
a voltage converting control circuit configured to provide a primary control signal to control the primary switch; and
a power supply control circuit for controlling a power supply voltage, comprising:
a charging control circuit configured to provide a charging control signal based on an input voltage and the power supply voltage, wherein the input voltage is configured to be received from an AC power supply through a rectifying circuit;
a charging current source coupled to the input voltage, and configured to provide a charging current to a power supply capacitor based on the charging control signal; and wherein
when the input voltage decreases to an input reference voltage, the charging control signal controls the charging current source to provide the charging current, when the power supply voltage increases to a charging stop reference voltage, the charging control signal controls the charging current source to stop providing the charging current.

13. The voltage converting circuit of claim 12, wherein the charging control circuit comprises:
an input reference voltage adjusting circuit configured to adjust the input reference voltage when the input reference voltage is different from the input voltage at the time of stopping providing the charging current.

14. The voltage converting circuit of claim 12, wherein the charging control circuit comprises:
an input voltage comparing circuit configured to provide an input voltage charging enable signal based on the input voltage and the input reference voltage;
a power supply voltage comparing circuit configured to provide a charging stop signal based on the power supply voltage and the charging stop reference voltage; and
a charging control logic circuit configured to provide the charging control signal to control the charging current source based on the input voltage charging enable signal and the charging stop signal.

15. The voltage converting circuit of claim 14, wherein the power supply voltage comparing circuit is further configured to provide a power supply voltage charging enable signal based on the power supply voltage and a charging reference voltage, and the charging control logic circuit is further configured to provide the charging control signal based on the input voltage charging enable signal, the power supply voltage charging enable signal and the charging stop signal.

16. The voltage converting circuit of claim 15, wherein:
when the input voltage decreases to the input reference voltage and the power supply voltage is lower than the charging reference voltage, the charging control signal controls the charging current source to provide the charging current.

17. The voltage converting circuit of claim 12, wherein the transformer comprises an auxiliary winding coupled to a charging terminal of the power supply capacitor through a diode.

18. A method for controlling a power supply voltage, comprising:
controlling a charging current source to provide a charging current for charging a power supply capacitor when an input voltage decreases to an input reference voltage;
controlling the charging current source to stop providing the charging current when the power supply voltage increases to a charging stop reference voltage; and
adjusting the input reference voltage when the input reference voltage is different from the input voltage at the time of stopping providing the charging current.

19. The method of claim 18, wherein the step of adjusting the input reference voltage comprises:
decreasing the input reference voltage when the input reference voltage is higher than the input voltage at the time of stopping providing the charging current; and
increasing the input reference voltage when the input reference voltage is lower than the input voltage at the time of stopping providing the charging current.

20. The method of claim 18, wherein controlling the charging current source to provide the charging current for charging the power supply capacitor when (i) the input voltage decreases to the input reference voltage, and (ii) the power supply voltage is lower than a charging reference voltage.

21. The method of claim 20, wherein the charging reference voltage is lower than the charging stop reference voltage.
